(19) United States
(12) Patent Application Publication
(10) Pub. No.: US 2012/0276936 A1
(43) Pub. Date: Nov. 1, 2012

(54) APPARATUS AND METHOD FOR REESTABLISHING RADIO LINK IN WIRELESS COMMUNICATION SYSTEM

(75) Inventors: Jae Hyun AHN, Seoul (KR); Ki Bum KWON, Seoul (KR); Myung Cheul JUNG, Seoul (KR)

(73) Assignee: PANTECH CO., LTD., Seoul (KR)

(21) Appl. No.: 13/458,743

(22) Filed: Apr. 27, 2012

(30) Foreign Application Priority Data
Apr. 30, 2011 (KR) 10-2011-0041214

(51) Int. Cl. H04W 28/04; H04W 76/00; H04W 24/04

(52) U.S. Cl. 455/501

(57) ABSTRACT

The present invention discloses an apparatus and method for performing radio link reestablishment in a wireless communication system. Furthermore, the present invention discloses a radio link reestablishment request message, including a reestablishment cause indicator on which whether a Radio Link Failure (RLF) was generated by User Equipment (UE) is determined, a cause of the occurrence of the RLF is determined, and whether the cause of the radio link reestablishment is In-Device Coexistence interference (IDC) due to the UE. Accordingly, a network may know a cause of the occurrence of an RLF generated during a handover. In particular, the network may know whether the cause of the occurrence of the RLF is a handover failure or RLF due to IDC. Consequently, a radio link can be efficiently reestablished, and also network parameters can be controlled.

### CROSS-REFERENCE TO RELATED APPLICATIONS

This application claims the benefit of priority of Korean Patent Application No. 10-2011-0041214 filed on Apr. 30, 2011, all of which is incorporated by reference in its entirety herein.

### BACKGROUND OF THE INVENTION

1. Field of the Invention

The present invention relates to a wireless communication system and, more particularly, to an apparatus and method for reestablishing a radio link in a wireless communication system.

2. Discussion of the Related Art

In general, a wireless communication system uses one bandwidth in order to transmit data. For example, the 2^{nd} generation wireless communication system uses a bandwidth of 200 KHz to 1.25 MHz, and the 3^{rd} generation wireless communication system uses a bandwidth of 5 MHz to 10 MHz. In order to support an increased transmission capacity, the recent bandwidth of the 3^{rd} Generation Partnership Project (3GPP) Long Term Evolution (LTE) or IEEE 802.16m is extending up to 20 MHz or higher. To increase the bandwidth in order to increase the transmission capacity may be considered to be indispensable, but to support a great bandwidth even when the quality of service required is low may cause great power consumption.

In order to solve this problem, there is emerging a multiple component carrier system in which a carrier having one bandwidth and the center frequency is defined and data is transmitted or received through a plurality of the carriers in a broad band. A narrow band and a broad band are supported at the same time by using one or more carriers. For example, if one carrier corresponds to a bandwidth of 5 MHz, a maximum 20 MHz bandwidth is supported by using four carriers.

With the help of the contemporary ubiquitous access network, users in different areas may access different networks and maintain the access at any place. In the prior art in which one terminal performed communication with one network system, a user had to carry different devices that support respective network systems. As the function of a single terminal is recently advanced and complicated, however, communication with a number of network systems becomes able to be performed using only the single terminal, and thus user convenience is increasing.

If one terminal performs communication on a number of network system bands at the same time, In-Device Coexistence interference (hereinafter referred to as ‘IDC’) may occur. IDC refers to interference when transmission in one frequency band generates interference with reception in the other frequency band within the same terminal. For example, if a single terminal supports a Bluetooth system and an 802.16 system at the same time, IDC may occur between a Bluetooth system band and an 802.16 system band. IDC may chiefly occur when spacing between the frequency band boundaries of heterogeneous network systems is not sufficient wide.

If a handover is failed due to IDC during the handover (or a radio link failure occurs), a network may erroneously determine that a cause of the handover failure is cell deployment between base stations, handover parameters, etc. If the network parameters are changed based on the wrong determination of the network, more handover failures may be caused when an IDC problem does not occur.

In order to avoid this problem, there is a need for a method capable of indicating that a radio link is reestablished owing to IDC, in particular, a radio link is reestablished owing to a handover failure due to IDC when the radio link is reestablished.

### SUMMARY OF THE INVENTION

An object of the present invention is to provide an apparatus and method for reestablishing a radio link with consideration taken of whether IDC has occurred or not.

Another object of the present invention is to provide an apparatus and method for transmitting and receiving information indicating whether IDC has occurred or not.

Yet another object of the present invention is to provide an apparatus and method for making a report by detecting a radio link failure in a wireless communication system.

Further yet another object of the present invention is to provide an apparatus and method for configuring a reestablishment cause indicator to indicate a radio link failure due to IDC in a wireless communication system.

Still yet another object of the present invention is to provide an apparatus and method for reporting a cause of a radio link failure in a wireless communication system.

Further yet another object of the present invention is to provide an apparatus and method for performing radio link reestablishment by distinguishing a radio link failure due to IDC and a common radio link failure from each other in a wireless communication system.

In accordance with an embodiment of the present invention, there is provided a method of User Equipment (UE) reestablishing a radio link in a wireless communication system, including detecting an occurrence of a Radio Link Failure (RLF) between the UE and an evolved NodeB (eNB), determining a cause of the occurrence of the RLF, generating a Radio Resource Control (RRC) connection reestablishment request message, including an RRC connection reestablishment cause indicator indicating whether the cause of the occurrence of the RLF is In-Device Coexistence interference (IDC) due to the UE, and sending the RRC connection reestablishment request message to the eNB.

The method may further include receiving an RRC connection reestablishment message from the eNB and reestablishing the failed radio link based on the RRC connection reestablishment message.

In the method, determining a cause of the occurrence of the RLF may be performed based on measurement results of Reference Signal Received Power (RSRP), Reference Signal Received Quality (RSRQ), a Channel Quality Indication (CQI), or a Signal to Interference and Noise Ratio (SINR).

In the method, the RRC reestablishment cause indicator may indicate whether the cause of the occurrence of the RLF is a handover failure due to the IDC of the UE.

In accordance with another embodiment of the present invention, there is provided UE performing RRC connection reestablishment in a wireless communication system, including an occurrence detection unit for detecting the occurrence of an RLF between the UE and an eNB, an occurrence cause determination unit for determining a cause of the occurrence of the RLF, and a request message transmission unit for generating an RRC connection reestablishment request message, including an RRC connection reestablishment cause indicator indicating whether the cause of the occurrence of the RLF is IDC due to the UE, and sending the RRC connection reestablishment request message to the eNB.

The UE may further include a response message reception unit for receiving an RRC connection reestablishment message from the eNB.

The occurrence cause determination unit of the UE may determine the cause of the occurrence of the RLF based on measurement results of RSRP, RSRQ, a CQI, or an SINR.

The RRC reestablishment cause indicator may indicate whether the cause of the occurrence of the RLF is a handover failure due to the IDC of the UE.

In accordance with yet another embodiment of the present invention, there is provided a method of an eNB reestablishing a radio link in a wireless communication system, including an RRC connection reestablishment request message, including an RRC connection reestablishment cause indicator indicating whether a cause of radio link reestablishment is IDC due to UE, from the UE, checking a cause of the occurrence of the RLF based on the RRC connection reestablishment cause indicator, and generating an RRC connection reestablishment message based on the cause of the occurrence of the RLF and sending the RRC connection reestablishment message to the UE.

The method may further include performing an operation of reducing the IDC of is the UE based on the cause of the occurrence of the RLF cause.

In the method, the RRC connection reestablishment cause indicator may indicate whether the cause of the occurrence of the RLF is a handover failure due to the IDC of the UE.

In accordance with still yet another embodiment of the present invention, there is provided an eNB performing radio link reestablishment in a wireless communication system, including a request message reception unit for receiving an RRC connection reestablishment request message, including an RRC connection reestablishment cause indicator indicating whether a cause of the radio link reestablishment is IDC due to UE, from the UE, an operation determination unit for checking a cause of the occurrence of the RLF based on the RRC connection reestablishment cause indicator and determining an operation to be performed, and a response message transmission unit for sending an RRC connection reestablishment message generated based on the cause of the occurrence of the RLF to the UE.

The eNB may further include an operation execution unit for performing an operation of reducing the IDC of the UE based on the cause of the occurrence of the RLF.

The reestablishment cause indicator may further indicate whether the cause of the occurrence of the RLF is a handover failure due to the IDC of the UE.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 shows a wireless communication system to which embodiments of the is present invention are applied;

FIG. 2 is an explanatory diagram illustrating IDC to which the present invention is applied;

FIG. 3 is an example showing IDC from an Industrial, Scientific and Medical (ISM) transmitter to an LTE receiver to which the present invention is applied;

FIG. 4 is a diagram schematically illustrating Radio Link Failure (RLF) to which the present invention is applied;

FIG. 5 is an explanatory diagram illustrating an example in which IDC is reduced by using an FDM scheme according to the present invention;

FIG. 6 is an explanatory diagram illustrating another example in which IDC is reduced by using an FDM scheme according to the present invention;

FIGS. 7 and 8 are explanatory diagrams illustrating examples in which UE reduces IDC by using a Power Control (PC) method according to the present invention;

FIG. 9 is an explanatory diagram illustrating an example in which IDC is reduced by using a TDM scheme according to the present invention;

FIG. 10 shows transmission and reception timings in the time axis of an LTE band and an ISM band by using a TDM scheme according to the present invention;

FIG. 11 is an explanatory diagram illustrating another example in which IDC is reduced by using a TDM scheme according to the present invention;

FIG. 12 is an explanatory diagram illustrating yet another example in which IDC is reduced by using a TDM scheme according to the present invention;

FIG. 13 is an explanatory diagram illustrating further another example in which IDC is reduced by using a TDM scheme according to the present invention;

FIG. 14 shows a handover failure due to IDC;

FIGS. 15 to 18 show some examples in which an RLF to which an embodiment of the present invention is applied is generated while a handover is performed;

FIG. 19 shows an example of an RRC connection reestablishment operation according to an embodiment of the present invention;

FIG. 20 shows another example of an RRC connection reestablishment operation according to an embodiment of the present invention;

FIG. 21 is a flowchart illustrating an embodiment of an operation of UE according to an embodiment of the present invention;

FIG. 22 is a flowchart illustrating an embodiment of an operation of an eNB according to an embodiment of the present invention;

FIG. 23 is a flowchart illustrating another embodiment of an operation of UE according to an embodiment of the present invention;

FIG. 24 is a flowchart illustrating another embodiment of an operation of an eNB according to an embodiment of the present invention; and

FIG. 25 is a block diagram of an apparatus for reestablishing RRC connection according to an embodiment of the present invention.

### DETAILED DESCRIPTION OF THE EMBODIMENTS

Hereinafter, in this specification, some exemplary embodiments are described in detail with reference to the accompanying drawings. It is to be noted that in assigning reference numerals to elements in the drawings, the same reference numerals designate the same elements throughout the drawings although the elements are shown in different drawings. Furthermore, in is describing the embodiments of the present invention, a detailed description of the known functions and constructions will be omitted if it is deemed to make the gist of the present invention unnecessarily vague.

Furthermore, in describing the elements of this specification, terminologies, such as the first, the second, A, B, (a), and (b), may be used. The terminologies are used to only distinguish elements from one another, but the essence, sequence and the like of the elements are not limited by the terminologies. Furthermore, in the case where one element is described to be “connected”, “coupled”, or “linked” to the other element, the one element may be directly connected or coupled to the other element, but it is be understood that a third element may be “connected”, “coupled”, or “linked” between the elements.

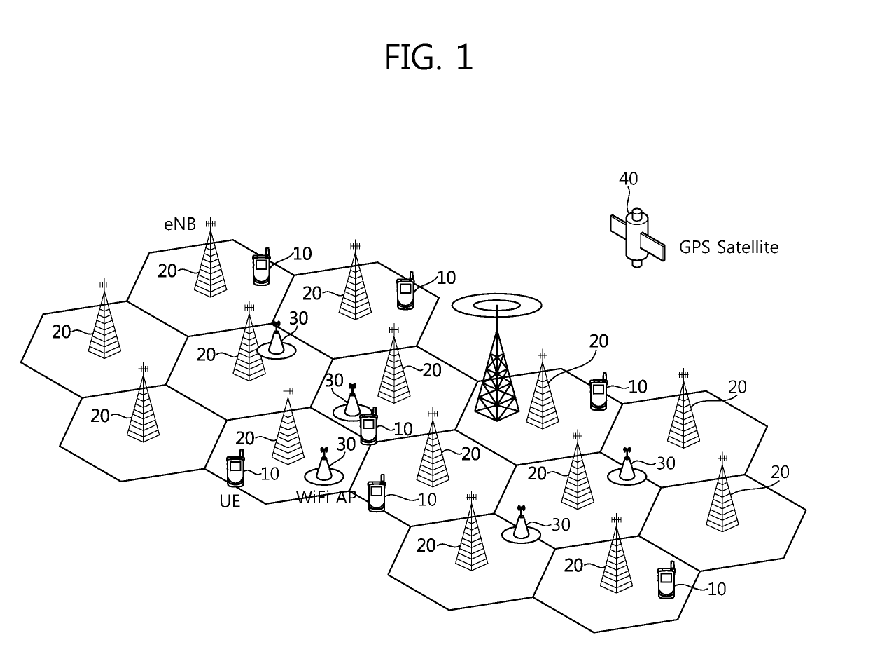

FIG. 1 shows a wireless communication system to which embodiments of the present invention are applied.

Referring to FIG. 1, a plurality of the wireless communication systems is widely deployed in order to provide a variety of communication services, such as voice and packet data. The wireless communication system includes User Equipments (UEs) 10, evolved NodeBs (eNBs) 20, Wireless LAN (WLAN) Access Points (APs) 30, and Global Positioning Systems (GPSs) 40 satellites. Here, a WLAN is an apparatus supporting IEEE 802.11 technology, that is, a wireless standard. IEEE 802.11 may also be called a Wi-Fi system.

The UE 10 may be placed in the coverage of each of a number of networks, such as a cellular network, a WLAN, a broadcast network, and a satellite system. In order for the UE 10 to access a variety of networks, such as the eNB 20, the WLAN AP 30, and the GPS 40, and a variety of services without being limited to the time and space, the UE 10 is equipped with a number of wireless transceivers. For example, a smart phone includes LTE, WiFi, and Bluetooth is (hereinafter referred to as a ‘BT’) transceivers, and a GPS receiver. In order to integrate a larger number of transceivers into the same UE 10 while maintaining good performance, the design of the UE 10 becomes complicated. For this reason, a possibility that In-Device Coexistence interference (IDC) will occur may be further increased.

Hereinafter, downlink refers to communication from the eNB 20 to the UE 10, and uplink refers to communication from the UE 10 to the eNB 20. In downlink, a transmitter may be a part of the eNB 20, and a receiver may be a part of the UE 10. Furthermore, in uplink, a transmitter may be a part of the UE 10, and a receiver may be a part of the eNB 20.

The UE 10 may be fixed or mobile. The UE 10 may also be called another terminology, such as a Mobile Station (MS), a User Terminal (UT), a Subscriber Station (SS), a Mobile Terminal (MT), or a Wireless Device. The eNB 20 refers to a fixed station communicating with the UE 10. The eNB 20 may also be called another terminology, such as a Base Station (BS), a Base Transceiver System (BTS), an Access Point (AP), a femto BS, a pico BS, or a relay.

Multiple access schemes applied to the wireless communication system are not limited. A variety of multiple access schemes, such as Code Division Multiple Access (CDMA), Time Division Multiple Access (TDMA), Frequency Division Multiple Access (FDMA), Orthogonal Frequency Division Multiple Access (OFDMA), Single Carrier-FDMA (SC-FDMA), OFDM-FDMA, OFDM-TDMA, and OFDM-CDMA, may be used. In uplink transmission and downlink transmission, a Time Division Duplex (TDD) method in which transmission is performed on different times may be used or a Frequency Division Duplex (FDD) method in which transmission is performed using different frequencies may be used.

A Carrier Aggregation (CA) is to support a plurality of component carriers and is also called a spectrum aggregation or a bandwidth aggregation. Each of individual unit carriers aggregated by a CA is called a Component Carrier (hereinafter referred to as a ‘CC’). Each CC is defined by the bandwidth and the center frequency. The CA is introduced in order to support an increasing throughput, prevent an increase of costs due to the introduction of a broadband Radio Frequency (RF) device, and guarantee compatibility with the existing system. For example, assuming that 5 CCs are allocated as the granularity of a carrier unit having a bandwidth of 5 MHz, a maximum bandwidth of 25 MHz can be supported. Hereinafter, a multiple carrier system refers to a system supporting the CA. The wireless communication system of FIG. 1 may be a multiple carrier system.

A system frequency band is classified into a plurality of carrier frequencies. The carrier frequency refers to the center frequency of a cell. The cell may mean a downlink CC and an uplink CC. Alternatively, the cell may mean a combination of a downlink CC and an optional uplink CC. Furthermore, if a CA is not taken into consideration, one cell always consists of a pair of uplink and downlink CCs.

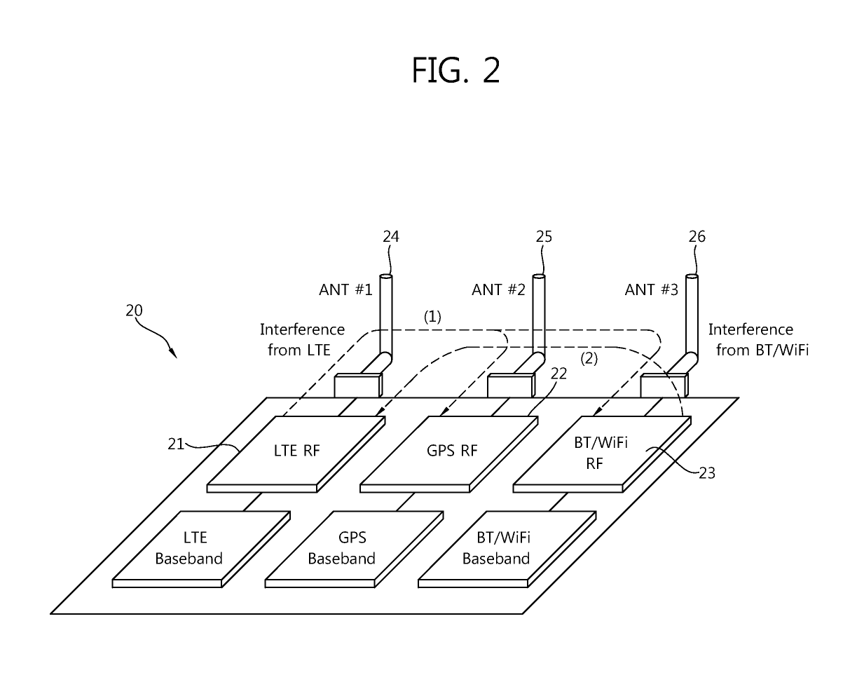

FIG. 2 is an explanatory diagram illustrating IDC to which the present invention is applied.

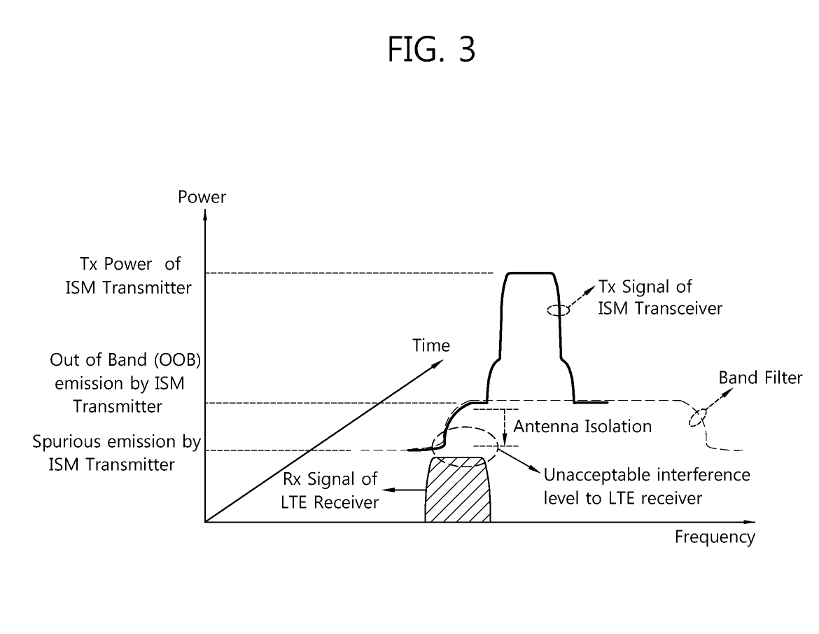

Referring to FIG. 2, the UE 20 includes an LTE Radio Frequency (RF) 21, a GPS RF 22, and a BT/WiFi RF 23. Transmission and reception antennas 24, 25, and 26 are coupled to the respective LTE RF 21, GPS RF 22, and BT/WiFi RF 23. That is, various kinds of RFs are proximately mounted within one device platform. Here, the transmission power level of one RF toward the other RF receiver may be very greater than the reception power level of the other RF. In this case, if frequency spacing between the RFs is not sufficiently wide and an advanced filtering technique is not supported, the transmission signal of one RF may generate significant is interference with the receiver of the other RF within the same device. For example, in FIG. 2, (1) shows an example in which the transmission signal of the LTE RF 21 generates IDC for the GPS RF 22 and the BT/WiFi RF 23, and (2) shows an example in which the transmission signal of the BT/WiFi RF 23 generates IDC for the LTE RF 21. An inter-signal effect caused by IDC is described in more detail with reference to FIG. 3.

FIG. 3 is an example showing IDC from an Industrial, Scientific and Medical (ISM) transmitter to an LTE receiver. An ISM band is a band which is freely used in the industrial, scientific, and medical fields without license. From FIG. 3, it can be seen that there is a portion where the band of a signal received by the LTE receiver overlaps with the band of a signal transmitted by the ISM transmitter. In this case, IDC may occur.

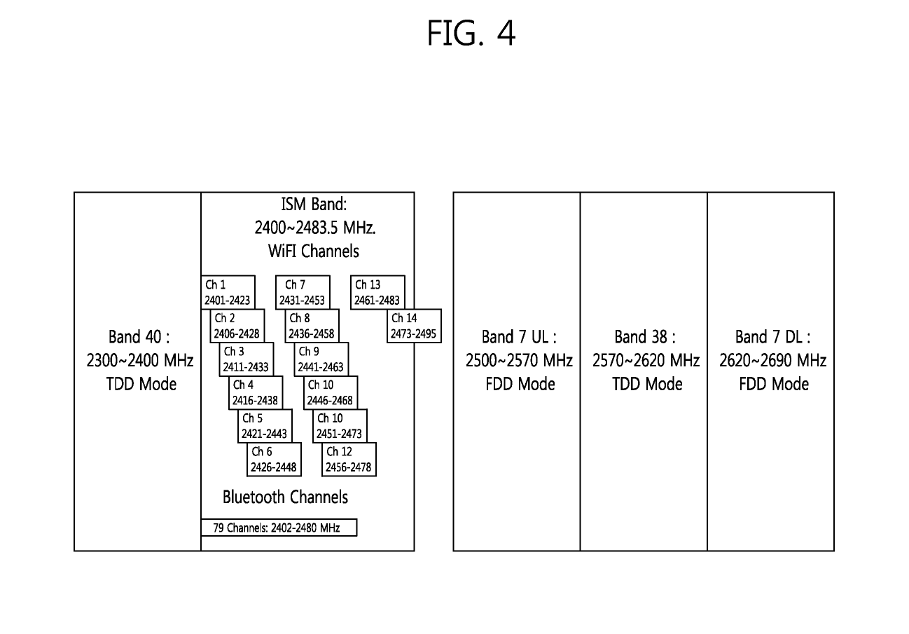

FIG. 4 is a diagram schematically illustrating Radio Link Failure (RLF) to which the present invention is applied.

Referring to FIG. 4, Band 40, Band 7, and Band 38 are LTE bands. Band 40 occupies a band of 2300 to 2400 MHz in the TDD mode, and Band 7 occupies a band of 2500 to 2570 MHz as uplink in the FDD mode. Furthermore, Band 38 occupies a band of 2570 to 2620 MHz in the TDD mode. Meanwhile, an ISM band is used as a WiFi channel and a Bluetooth channel, and they occupy a band of 2400 to 2483.5 MHz. Here, situations in which IDC occurs are shown in Table 1.

TABLE 1

| Interference Band | Type of Interference |
|---|---|
| Band 40 | ISM Tx -> LTE TDD DL Rx |
| Band 40 | LTE TDD UL Tx -> ISM Rx |
| Band 7 | LTE FDD UL Tx -> ISM Rx |
| Band 7/13/14 | LTE FDD UL Tx -> GPS Rx |

Referring to Table 1, in the types of interference, a mark ‘a->b’ indicates a situation in which a transmitter a generated IDC to a receiver b. Accordingly, in Band 40, an ISM transmitter generates IDC toward a downlink TDD receiver (i.e., LTE TDD DL Rx) of the LTE band. IDC may be reduced to some extent by using a filtering scheme, but it is not sufficient. IDC may be reduced more efficiently by additionally applying the FDM scheme to the filtering method.

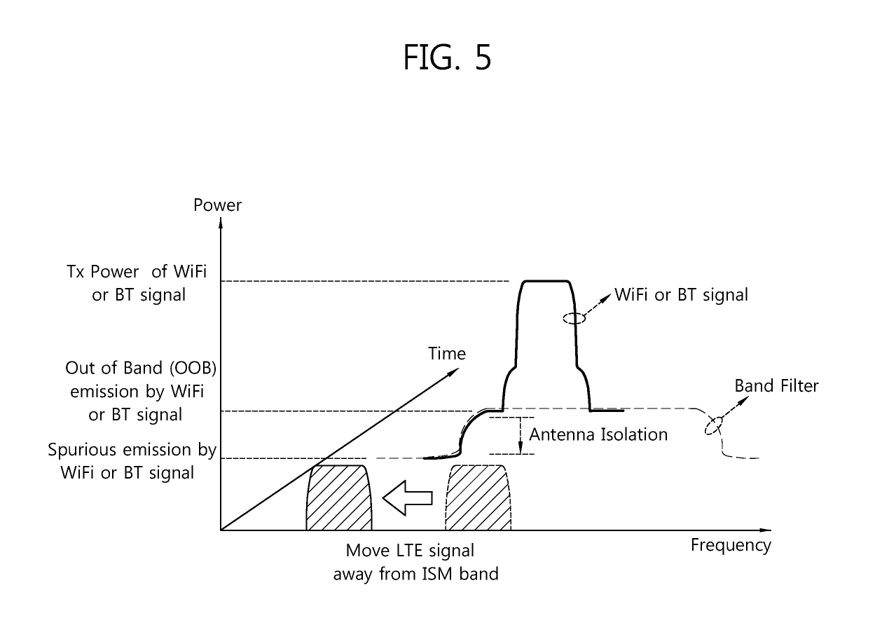

FIG. 5 is an explanatory diagram illustrating an example in which IDC is reduced by using an FDM scheme according to the present invention.

Referring to FIG. 5, the LTE band may be moved so that the LTE band does not overlap with the ISM band. It results in the handover of UE from the ISM band. To this end, there is a need for a method of precisely triggering a mobility procedure or an RLF procedure based on legacy measurement or new signaling. Alternatively, there may be a scheme for avoiding parts within the LTE band that may be problematic with the ISM band through the filtering scheme or a resource allocation scheme. Alternatively, if an LTE CA is used, overlapping interference may be avoided by an RRC reconfiguration in which an aggregation of carriers used is reconfigured.

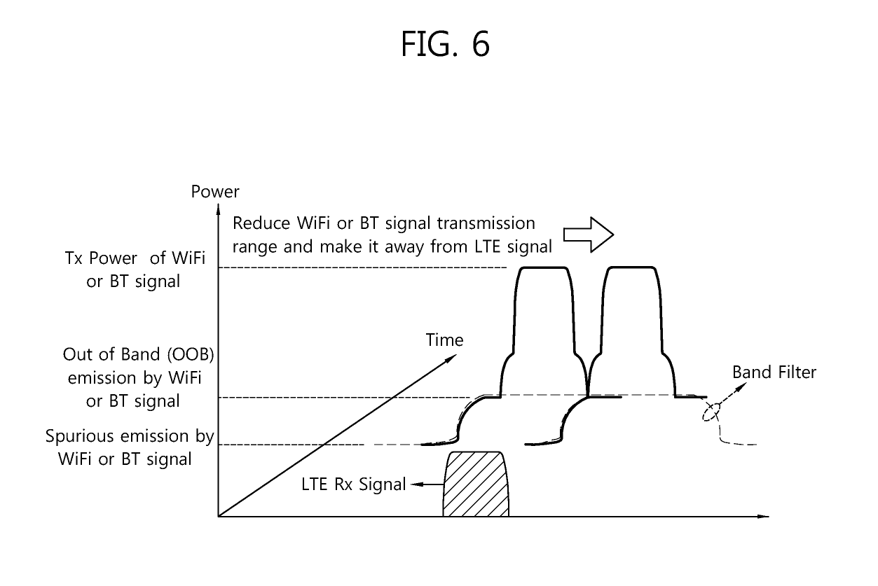

FIG. 6 is an explanatory diagram illustrating another example in which IDC is reduced using an FDM scheme according to the present invention.

Referring to FIG. 6, the ISM band may be reduced and may be moved so that it is far from the LTE band. In this method, however, a backward compatibility problem may occur. In case of Bluetooth, the backward compatibility problem may be solved to some extent by an adaptive frequency hopping mechanism, but in case of WiFi, the backward compatibility is problem may not be solved.

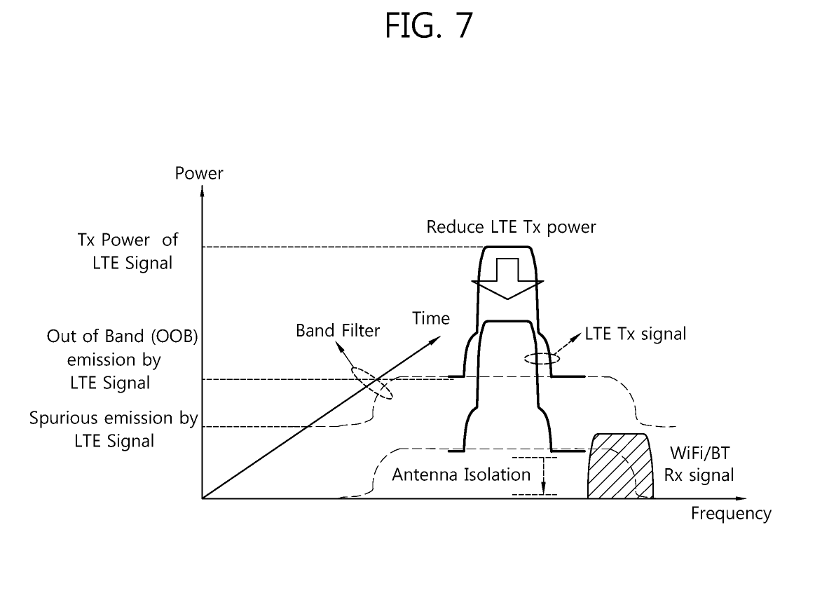

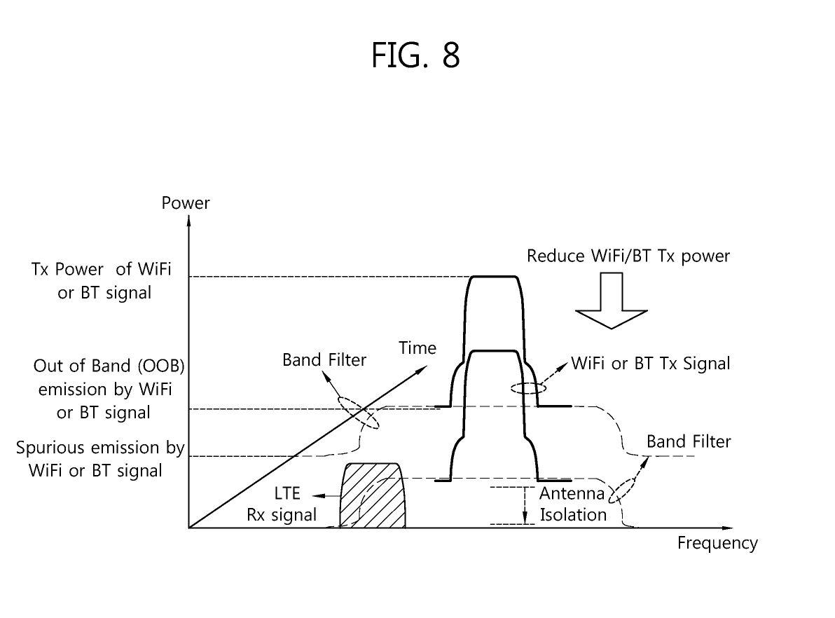

FIGS. 7 and 8 are explanatory diagrams illustrating examples in which UE reduces IDC by using a Power Control (PC) method according to the present invention.

Referring to FIG. 7, UE may avoid IDC by lowering the transmission (Tx) power of an LTE signal to some extent in order to improve the reception quality of the ISM band.

Referring to FIG. 8, UE may avoid IDC by lowering the transmission (Tx) power of the ISM band to some extent in order to improve the reception quality of the LTE signal.

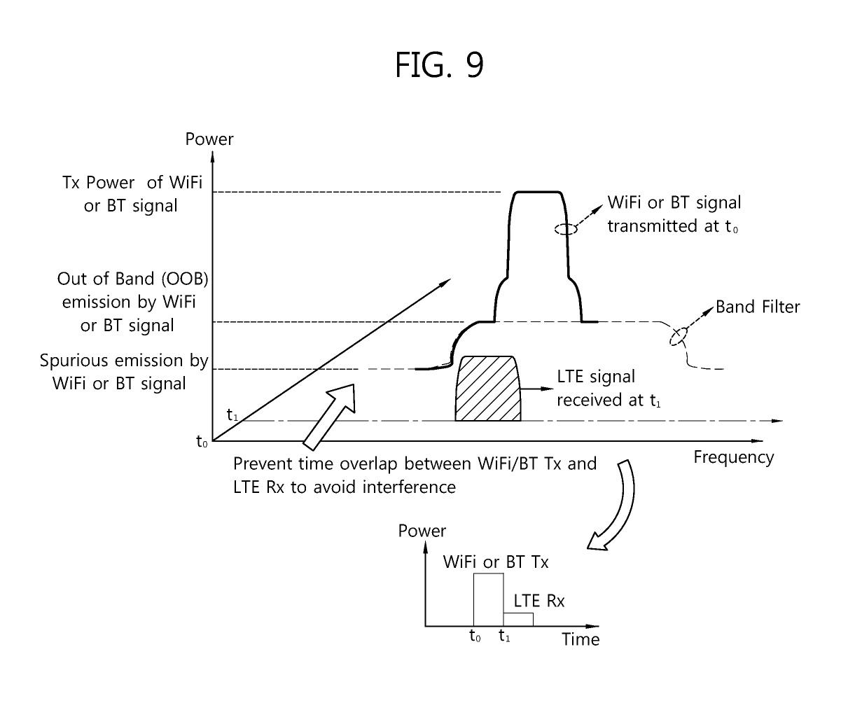

FIG. 9 is an explanatory diagram illustrating an example in which IDC is reduced using a TDM scheme according to the present invention.

Referring to FIG. 9, IDC may be avoided by not overlapping the time when an LTE signal is received with the transmission time in the ISM band. For example, when a signal of the ISM band is transmitted at t₀, an LTE signal may be received at t₁.

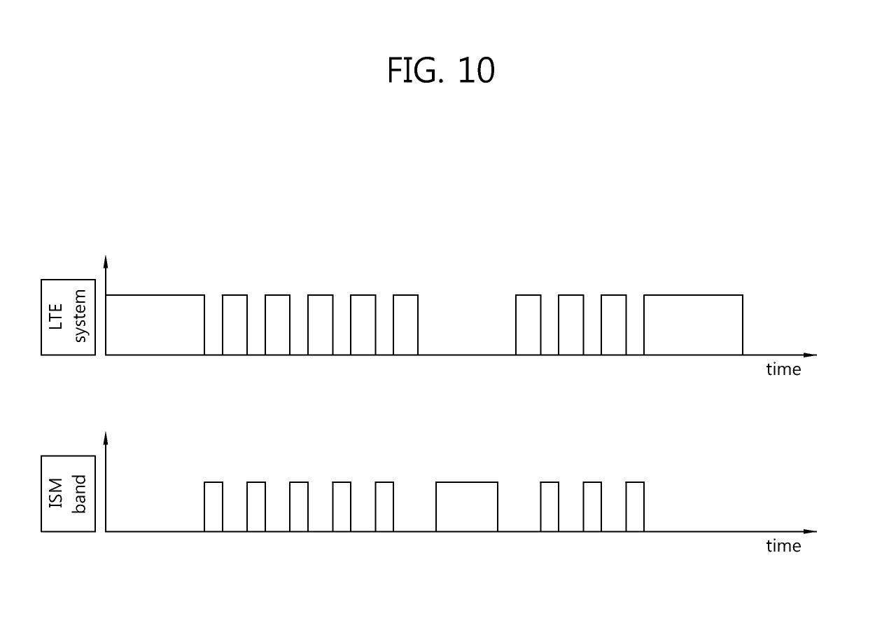

The transmission and reception timings in the time axis of the LTE band and the ISM band using the TDM scheme according to the present invention as described above may be shown in FIG. 10.

From FIG. 10, it can be seen that IDC may be avoided without movement between the LTE band and the ISM band by using a method, such as that shown in FIG. 9.

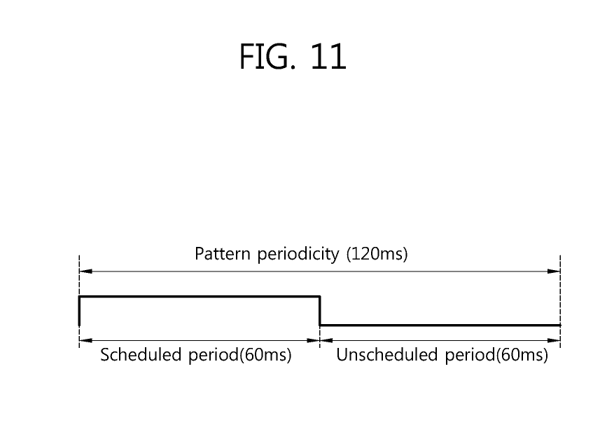

FIG. 11 is an explanatory diagram illustrating another example in which IDC is reduced by using a TDM scheme according to the present invention.

The example of FIG. 11 corresponds to a TDM scheme based on discontinuous reception (DRX). In this TDM scheme, IDC may be avoided by dividing a specific pattern periodicity into a scheduled period and an unscheduled period.

Mutual interference between LTE and ISM is avoided by preventing LTE is transmission within the unscheduled period. However, major LTE transmission, such as random access and Hybrid Automatic Repeat ReQuest (HARQ) re-transmission, may be permitted even within the scheduled period.

Mutual interference between LTE and ISM is avoided by preventing ISM transmission and permitting LTE transmission within the scheduled period. Like in the unscheduled period, major ISM transmission, such as a beacon or WiFi, may be permitted within the scheduled period. In order to protect this major ISM transmission, LTE transmission may be prevented. Special signaling for protecting major ISM transmission, such as a beacon, may be added. For example, a beacon signaling period and subframe offset information may be added. In this case, a subframe offset number and a system frame number may be determined on the basis of 0. The system frame number is a value that may have one of 0 to 1023 per radio frame in an LTE system. One radio frame consists of 10 subframes. If a relevant subframe offset number and a relevant system frame number are known, a precise frame position in a relevant system can be known.

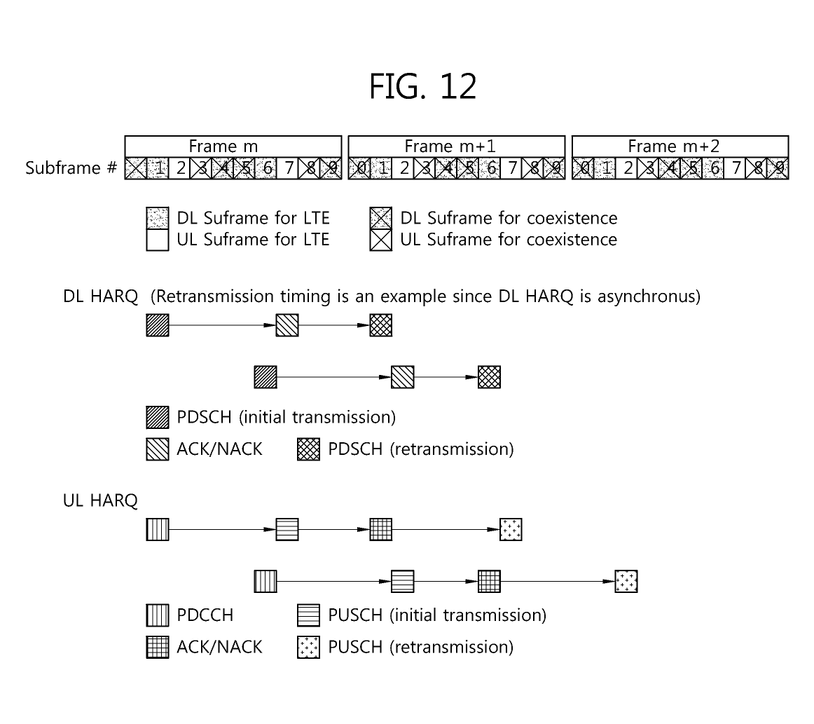

FIG. 12 is an explanatory diagram illustrating yet another example in which IDC is reduced by using a TDM scheme according to the present invention.

The example of FIG. 12 corresponds to a TDM scheme based on an HARQ. It is preferred that a re-transmission signal be protected when data is transmitted based on an HARQ. Here, the term ‘protected’ means that re-transmission is necessarily performed. If re-transmission is not performed in order to reduce or avoid IDC according to a TDM scheme, system performance may be significantly deteriorated. In this method, a transmission pattern is determined by taking a re-transmission period into consideration based on the deterioration of system performance. Nos. 1 and 6 subframes are reserved for downlink (DL) transmission, and Nos. 2 and 7 subframes are reserved for uplink (UL) transmission. The reserved subframes are also called scheduled subframes. In order to reduce IDC, unscheduled subframes may not be used for transmission in order to protect the ISM band.

Like in the method based on DRX, in the method based on an HARQ, subframes scheduled for transmission may not be used in order to perform important signaling transmission in the ISM band. In contrast, the transmission of important messages, such as random access, system information, and a paging signal, may be permitted even in an unscheduled subframe.

This pattern may have a bitmap pattern. That is, the number of subframes indicated by one bit may be 1 or higher. The period of the pattern may be (the total length of bitmap*the number of subframes per bit). Furthermore, each bit may have 0 when a subframe indicated by the bit is a scheduled subframe and may have 1 when a subframe indicated by the bit is an unscheduled subframe. Alternatively, each bit may have 1 when a subframe indicated by the bit is a scheduled subframe and may have 0 when a subframe indicated by the bit is an unscheduled subframe.

For example, it is assumed that a period is 20, a pattern indicating a subframe is “1001001000”, an unscheduled subframe has a value of 0, and the number of subframes indicated by one bit is 2. In a pattern indicating a subframe, the 1^{st}, 4^{th}, and 7^{th} bits have a value of 1. Thus, it can be seen that 0^{th}, 1^{st}, 6^{th}, 7^{th}, 12^{th}, and 13^{th} subframes are scheduled subframes in each period.

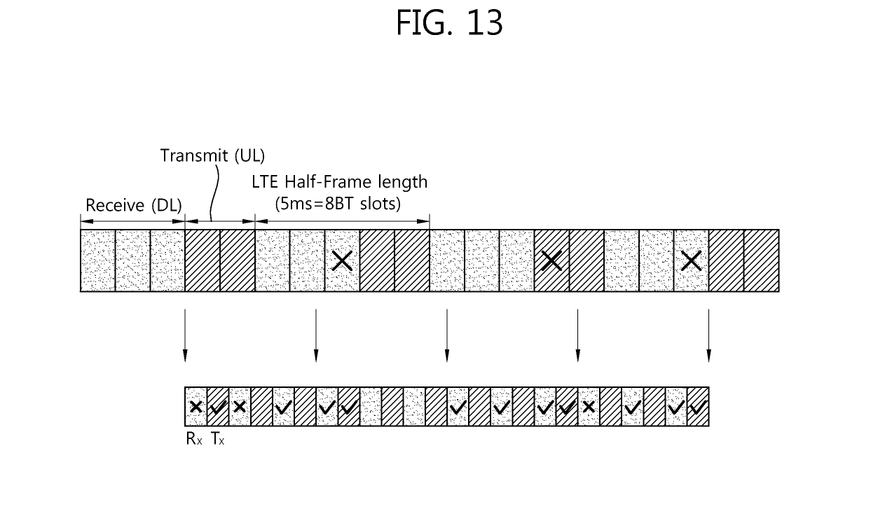

FIG. 13 is an explanatory diagram illustrating further another example in which IDC is reduced by using a TDM scheme according to the present invention.

The example of FIG. 13 corresponds to an autonomous denial method using a TDM scheme. When IDC is generated in UE, transmission is denied in order to protect ISM is reception in case of LTE. In FIG. 13, a checked part indicates that transmission or reception is permitted, and a part indicated by ‘X’ indicates that transmission or reception is denied. Although UL transmission is granted by an eNB, UE does not perform the UL transmission by denying the grant in order to protect ISM reception. Likewise, in case of ISM, UE denies transmission in order to protect LTE reception.

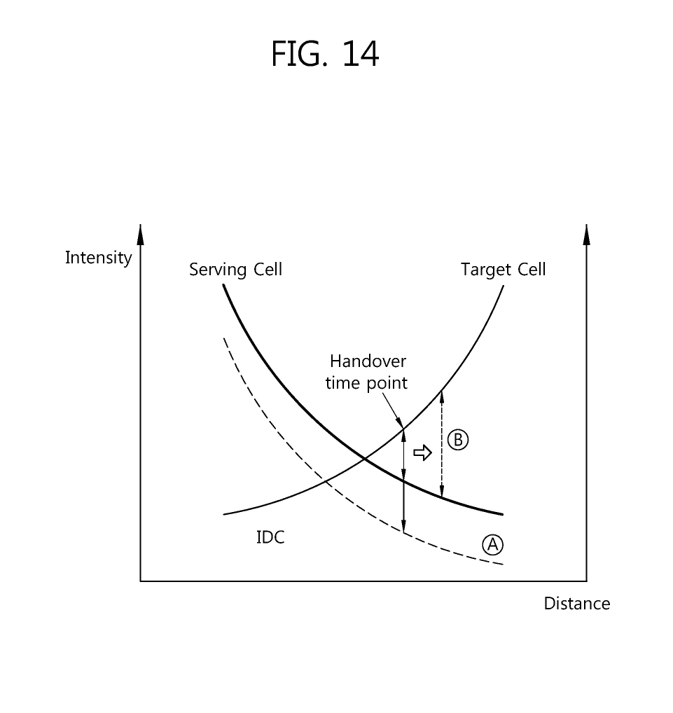

FIG. 14 shows a handover failure due to IDC.

Referring to FIG. 14, a handover time point is indicated as shown in FIG. 14 from a viewpoint of pathloss.

If a handover was failed owing to IDC, but only an indication of the handover failure was transferred to a network without a cause of the handover failure, the network may determine(or judge, or decide) that a cause of the handover failure is erroneous cell deployment between eNBs or erroneous handover parameters (e.g., an erroneous handover triggering threshold). Then, the network may modify the cell deployment or the handover parameter. For example, the network may change the handover triggering threshold into a value (i.e., a part A in FIG. 14) in which IDC is taken into consideration. If the network parameter is changed by taking the IDC into consideration, however, the triggering threshold becomes too high when IDC is not generated because the IDC is temporarily generated in specific UE. Accordingly, there is a high possibility that more handover failure may be generated.

In order to prevent this problem, there is a need for an operation in which a network distinguishes a handover failure due to handover parameters and a handover failure due to IDC from each other and, if a handover is failed due to Radio Link Failure (RLF) resulting from IDC, indicates that the handover parameters be not modified. For example, there is an operation of changing a handover time point into a part B of FIG. 14.

A method of reestablishing Radio Resource Control (RRC) connection when an RLF is generated owing to IDC according to the present invention is described below.

First, the case where an RLF is generated is described. The occurrence of an RLF means a state in which it is difficult to receive a message because of a deteriorated radio link state. In LTE, the state is determined on the basis of the reception ratio of a Physical Downlink Control Channel (PDCCH). When an RLF occurs, UE attempts to solve the problem by using a method, such as connection reestablishment or cell reselection, because it is difficult to receive a message. The RLF may be generated in the coverage hole of a relevant eNB or may be generated by a deteriorated channel state during handover. Here, the coverage hole may be within the communication coverage of the eNB in terms of a geographical position, but refers to a position where the channel state is suddenly deteriorated for various reasons.

First, an RLF is generated in case of out-of-sync (i.e., an out-of-sync phenomenon). When UE measures channel quality, UE determines that an out-of-sync phenomenon was generated if the number of times that a value smaller than a preset threshold Qout is consecutively measured is the preset number of times or higher as a result of the measurement, and thus operates a timer. If the number of times that a value greater than the preset threshold Qout is consecutively measured is not the preset number of times or higher before the time expires, an in-sync phenomenon is generated and thus an RLF is not generated. If an in-sync phenomenon is not generated until the timer expires, however, the UE finally determines an out-of-sync phenomenon, and thus an RLF is generated.

Second, an RLF is generated when RRC connection setup fails. In order to set up RRC connection, UE sends an RRC connection request message to an eNB and operates a timer. If the UE does not receive an RRC connection setup message from the eNB before the timer expires, the UE fails in the RLF connection setup, and thus an RLF is generated. If the UE receives the RRC connection setup message from the eNB before the timer expires, however, the RRC connection setup is successful, and thus the UE sends an RRC connection setup complete message to the eNB.

Third, an RLF is generated when an RRC connection reconfiguration fails. An eNB sends an RRC connection reconfiguration message to UE and operates a timer. If the eNB does not receive an RRC connection reconfiguration complete message from the UE before the timer expires, the RRC connection reconfiguration fails, and thus an RLF is generated. The failure of the RRC connection reconfiguration includes that handover fails. Handover also includes mobility control information within the RRC connection reconfiguration message.

Fourth, an RLF is generated when RRC connection reestablishment fails. UE sends an RRC connection reestablishment request message to an eNB and operates a timer. If the UE does not receive an RRC connection reestablishment message from the eNB before the timer expires, the UE fails in the RRC connection reestablishment and thus an RLF is generated. If the UE receives the RRC connection reestablishment message from the eNB before the timer expires, however, the RRC connection reestablishment is successful, and thus UE sends an RRC connection reestablishment complete message to the eNB.

Fifth, an RLF is generated even when a maximum re-transmission number is exceeded on Radio Link Control (RLC).

In this case, when an RLF is generated, UE detects the occurrence of the RLF. Next, the UE (or an eNB) takes a different action depending on whether Access System (AS) security has been activated. If the AS security has not been activated, the UE (or an eNB) releases RRC connection and reselects a cell. If the AS security has been activated, the UE (or is an eNB) performs RRC connection reestablishment. The present invention relates to the case where AS security is activated, that is, UE performs RRC connection reestablishment without releasing RRC connection.

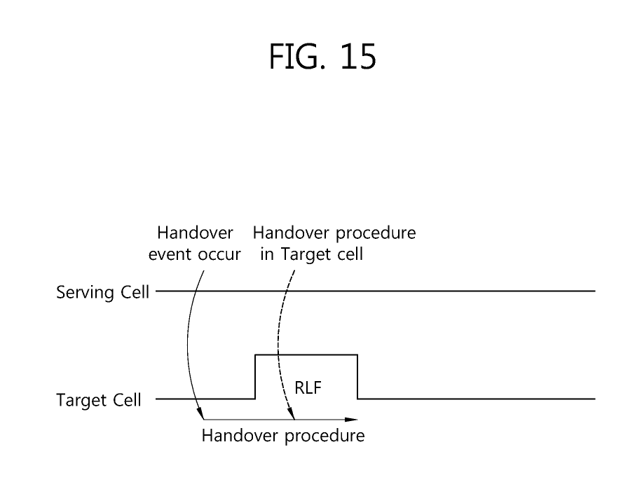

FIGS. 15 to 18 show some examples in which an RLF to which an embodiment of the present invention is applied is generated while a handover is performed.

Referring to FIG. 15, UE may fail in a handover when an RLF is generated because IDC is generated in a target cell, while performing the handover from a serving cell to the target cell.

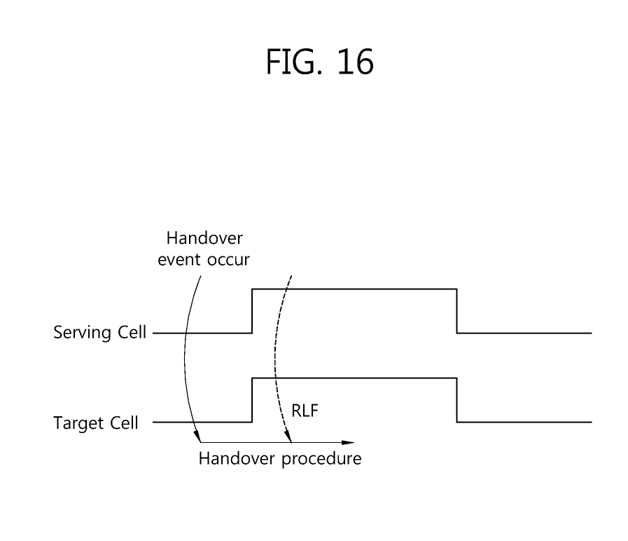

Referring to FIG. 16, UE may fail in a handover when an RLF is generated because IDC is generated in both a target cell and a serving cell, while performing the handover from the serving cell to the target cell.

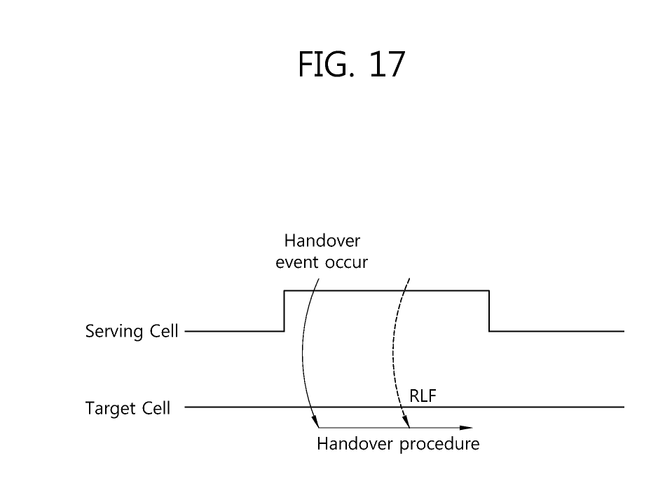

Referring to FIG. 17, UE may fail in a handover when an RLF is generated because IDC is generated in a serving cell, while performing the handover from the serving cell to a target cell.

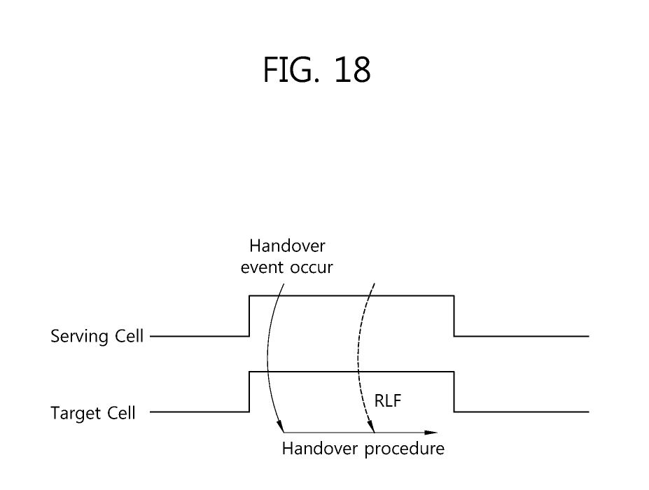

Referring to FIG. 18, UE may fail in a handover when an RLF is generated because IDC is generated in a target cell and a serving cell, while performing the handover from the serving cell to the target cell in the same frequency band.

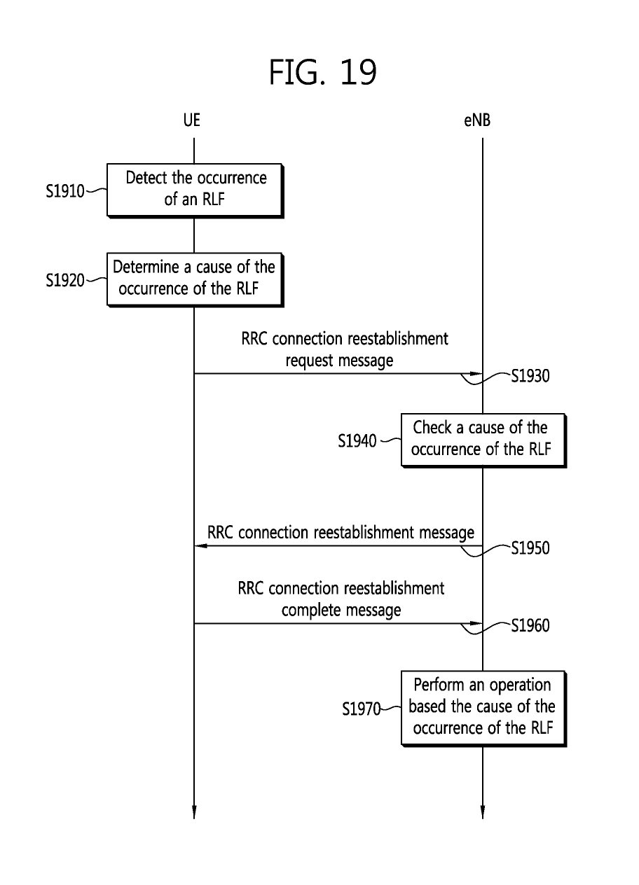

FIG. 19 shows an example of an RRC connection reestablishment operation according to an embodiment of the present invention.

Referring to FIG. 19, UE detects the occurrence of an RLF at step S1910. Furthermore, the UE determines(or distinguish or differentiate or discriminate) a cause of the RLF at step S1920. In particular, the UE determines whether a cause of the RLF is IDC. This is for distinguishing an RLF due to IDC from a common handover failure as described above.

Whether a cause of the RLF is IDC may be determined by one of the following methods or a combination of the three methods.

First, whether a cause of the RLF is IDC may be determined by determining whether the IDC has occurred or not. If the UE detected the occurrence of the IDC when the RLF occurred (or before or after the RLF occurred), the UE may determine that the RLF resulted from the IDC.

Second, whether a cause of the RLF is IDC may be determined by determining the intensity of the IDC. If the UE detected the occurrence of the IDC when the RLF occurred (or before or after the RLF occurred), the UE may determine that the RLF resulted from the IDC when the intensity of the IDC is a preset threshold or higher. The intensity of the IDC may be determined by the intensity of only the IDC or may be determined by measuring Reference Signal Received Power (RSRP), Reference Signal Received Quality (RSRQ), a Channel Quality Indication (CQI) or a Signal to Interference and Noise Ratio (SINR). For example, the intensity of IDC may be known by determining whether an RSRQ value is reduced because the RSRQ value will be reduced by the IDC. If the intensity of the RSRQ value is smaller than a preset threshold, the UE may determine that the RLF occurred owing to the IDC.

Third, whether a cause of the RLF is IDC may be determined by determining whether packet loss occurred due to the IDC. If the UE detects the occurrence of the IDC when the RLF occurred (or before or after the RLF occurred) and detects the occurrence of packet loss, the UE may determine that the RLF was generated owing to the IDC.

The UE determines a cause of the occurrence of the RLF as described above. In response thereto, the UE requests RRC connection reestablishment by sending an RRC connection reestablishment request message to an eNB at step S1930. Here, the RRC connection is reestablishment request message may include an RRC connection reestablishment cause indicator that indicates a cause of reestablishing RRC connection (or a cause of the occurrence of an RLF). Hereinafter, the RRC connection reestablishment cause indicator is called a reestablishment cause indicator.

Table 2 below shows an example of the RRC connection reestablishment request message transmitted from the UE to the eNB in order to reestablish RRC connection.

TABLE 2
RRCConnectionReestablishmentRequest message
-- ASN1START
RRCConnectionReestablishmentRequest ::= SEQUENCE {

| | |
|---|---|
| criticalExtensions | CHOICE { |

rrcConnectionReestablishmentRequest

RRCConnectionReestablishmentRequest-IEs,

| | |
|---|---|
| criticalExtensionsFuture | SEQUENCE { } |

}
}
RRCConnectionReestablishmentRequest-IEs ::= SEQUENCE {

| | |
|---|---|
| ue-Identity | ReestabUE-Identity, |
| reestablishmentCause | ReestablishmentCause, |
| spare | BIT STRING (SIZE (2)) |

}

| | |
|---|---|
| ReestabUE-Identity ::= | SEQUENCE { |

| | |
|---|---|
| c-RNTI | C-RNTI, |

| | |
|---|---|
| physCellId | PhysCellId, |
| shortMAC-I | ShortMAC-I |

}

| | |
|---|---|
| ReestablishmentCause ::= | ENUMERATED { |

```
  reconfigurationFailure, handoverFailure,
  otherFailure, spare1}
```

-- ASN1STOP

Here, ReestablishmentCause is the reestablishment cause indicator. Furthermore, the reestablishment cause indicator may indicate one of values reconfigurationFailure, handoverFailure, and otherFailure. sparel means an empty space for a reestablishment cause indicator to be added.

If the reestablishment cause indicator indicates handoverFailure, it means that a cause of the RRC connection reestablishment is a handover failure. If the eNB attempts to perform a handover by sending the RRC connection reconfiguration message, including mobility control information, to the UE, but fails in an RRC connection reconfiguration, the RLF occurs, and thus the RRC connection reestablishment is performed.

If the reestablishment cause indicator indicates reconfigurationFailure, it means that a cause of the RRC connection reestablishment is a failure in the common RRC connection reconfiguration process other than a handover.

If the reestablishment cause indicator indicates otherFailure, it means that a cause of the RRC connection reestablishment is a cause other than the two kinds of causes. For example, the RLF may be generated owing to out-of-sync or the RLF may be generated because a maximum re-transmission number is exceeded on RLC.

Tables 3 to 5 show other examples of the RRC connection reestablishment request message according to the present invention. A value indicated by the reestablishment cause indicator is differently set in each RRC connection reestablishment request message. However, parts other than the reestablishment cause indicator, from the RRC connection reestablishment request message, are identical with those of the RRC connection reestablishment request message of Table 2 (e.g., parts, such as RRCConnectionReestablishmentRequest, RCConnectionReestablishmentRequest-IEs, and ReestabUE-Identity in Table 2).

Table 3 shows an RRC connection reestablishment request message in which the reestablishment cause indicator may also indicate a value failureDueToIdc other than reconfigurationFailure, handoverFailure, and otherFailure. failureDueToIdc indicates that a cause of RRC connection reestablishment is an RLF generated owing to IDC in a serving cell or a serving eNB irrespective of a handover. In addition to the failure of a handover, an RLF may be generated even when a radio link fails because there is a hole in the coverage. Thus, RRC connection is reestablished.

TABLE 3

RRCConnectionReestablishmentRequest message
-- ASN1START
RRCConnectionReestablishmentRequest ::= SEQUENCE {

| | |
|---|---|
| criticalExtensions | CHOICE { |

rrcConnectionReestablishmentRequest

RRCConnectionReestablishmentRequest-IEs,

| | |
|---|---|
| criticalExtensionsFuture | SEQUENCE { } |

}

}
RRCConnectionReestablishmentRequest-IEs ::= SEQUENCE {

| | |
|---|---|
| ue-Identity | ReestabUE-Identity, |
| reestablishmentCause | ReestablishmentCause, |
| spare | BIT STRING (SIZE (2)) |

| } | |
|---|---|
| ReestabUE-Identity ::= | SEQUENCE { |

| | |
|---|---|
| c-RNTI | C-RNTI, |

| | |
|---|---|
| physCellId | PhysCellId, |
| shortMAC-I | ShortMAC-I |

| } | |
|---|---|
| ReestablishmentCause ::= | ENUMERATED { |

reconfigurationFailure, handoverFailure, otherFailure,
failureDueToIdc

}
-- ASN1STOP

In Table 3, if the reestablishment cause indicator indicates failureDueToIdc, it means that a cause of RRC connection reestablishment is an RLF generated due to IDC (it is not related to a handover failure). If the reestablishment cause indicator indicates handoverFailure, it means that a cause of RRC connection reestablishment is a handover failure, that is, a cause other than IDC. If the reestablishment cause indicator indicates reconfigurationFailure, it means that a cause of RRC connection reestablishment is a failure in the common RRC connection reconfiguration process other than the above-described handover. If the reestablishment cause indicator indicates otherFailure, it means that a cause of RRC connection reestablishment is a cause other than the three kinds of causes.

If the reestablishment cause indicator included in the RRC connection reestablishment request message received by the eNB indicates failureDueToIdc and thus indicates that a cause of the RRC connection reestablishment is IDC due to the UE, the eNB may perform a reduction of the IDC without influencing handover parameters or network parameters. The handover parameters refer to a parameter related to a handover, from among the network parameters. For example, the handover parameters may include a threshold to determine a handover or a timer taken until a handover is performed. The network parameters refer to parameters which are not relate to a handover, but used for a network configuration. For example, the network parameters may include a threshold for controlling loading between cells.

Furthermore, if the UE has performed the RRC connection reestablishment, the UE may perform a reduction of the IDC (e.g., TDM) in a target eNB or a target cell with reference the occurrence of the IDC.

If the reestablishment cause indicator included in the RRC connection reestablishment request message received by the eNB indicates handoverFailure, a network may determine that handover parameters between eNBs or cells are not correctly set and modify handover parameters between the eNBs or the cells. That is, handoverFailure indicates a handover failure not generated by IDC.

Table 4 shows an RRC connection reestablishment request message in which the reestablishment cause indicator may have a value handoverFailureDueToldc other than reconfigurationFailure, handoverFailure, and otherFailure. handoverFailureDueToldc indicates that an RLF was generated owing to IDC while UE performs a handover from a serving cell to a target cell.

TABLE 4

RRCConnectionReestablishmentRequest message
- ASN1START
RRCConnectionReestablishmentRequest ::= SEQUENCE {

| criticalExtensions | CHOICE { |
|---|---|
| rrcConnectionReestablishmentRequest | |
| RRCConnectionReestablishmentRequest-IEs, | |
| criticalExtensionsFuture | SEQUENCE { } |

}

}
RRCConnectionReestablishmentRequest-IEs ::= SEQUENCE {

| | |
|---|---|
| ue-Identity | ReestabUE-Identity, |
| reestablishmentCause | ReestablishmentCause, |
| spare | BIT STRING (SIZE (2)) |

| } | |
|---|---|
| ReestabUE-Identity ::= | SEQUENCE { |

| | |
|---|---|
| c-RNTI | C-RNTI, |
| physCellId | PhysCellId, |
| shortMAC-I | ShortMAC-I |

| } | |
|---|---|
| ReestablishmentCause ::= | ENUMERATED { |

reconfigurationFailure, handoverFailure, otherFailure,

handoverFailureDueToIdc}
-- ASN1STOP

In Table 4, if the reestablishment cause indicator indicates handoverFailureDueToIdc, it means that a cause of RRC connection reestablishment is a handover failure, in particular, a handover failure due to IDC. If the reestablishment cause indicator indicates handoverFailure, it means that a cause of RRC connection reestablishment is a handover failure not related to IDC. If the reestablishment cause indicator indicates reconfigurationFailure, it means that a cause of RRC connection reestablishment is a failure in the common RRC connection reconfiguration process other than the two kinds of handover failures. If the reestablishment cause indicator indicates otherFailure, it means that a cause of RRC connection reestablishment is a cause other than the three kinds of causes. In particular, if an RLF was generated owing to IDC not related to a handover failure, from among the RLFs due to IDC, the reestablishment cause indicator indicates otherFailure. For example, a radio link may fail because there is an empty hole in the coverage.

If the reestablishment cause indicator included in the RRC connection reestablishment request message received by the eNB indicates handoverFailureDueToldc and thus the eNB identifies that a cause of the RRC connection reestablishment is IDC due to the UE, the eNB may perform an IDC reduction without influencing handover parameters or network parameters. That is, the eNB has failed in a handover, but does not modify the handover parameters because the handover failure results from IDC. Furthermore, if the UE has performed the RRC connection reestablishment, the UE may also perform an IDC reduction (e.g., TDM) in a target eNB or a target cell with reference to the occurrence of the IDC.

If the reestablishment cause indicator included in the RRC connection reestablishment request message received by the eNB indicates handoverFailure, a network may is determine that handover parameters between eNBs or cells are not correctly set and may modify the handover parameters between the eNBs or the cells. That is, handoverFailure indicates a handover failure not generated owing to IDC.

Table 5 shows an RRC connection reestablishment request message in which the reestablishment cause indicator may also have values failureDueToldc and handoverFailureDueToldc other than reconfigurationFailure, handoverFailure, and otherFailure. That is, the reestablishment cause indicator of Table 5 may have both the value failureDueToldc of Table 3 and the value handoverFailureDueToldc of Table 4. handoverFailureDueToldc indicates that an RLF was generated owing to IDC while UE performs a handover form a serving cell to a target cell. failureDueToIdc indicates that an RLF was generated by causes not a handover owing to IDC due to UE.

TABLE 5

RRCConnectionReestablishmentRequest message
-- ASN1START
RRCConnectionReestablishmentRequest ::= SEQUENCE {

| criticalExtensions | CHOICE { |
|---|---|
| rrcConnectionReestablishmentRequest | |
| RRCConnectionReestablishmentRequest-IEs, | |
| criticalExtensionsFuture | SEQUENCE { } |

}
}

RRCConnectionReestablishmentRequest-IEs ::= SEQUENCE {

| | |
|---|---|
| ue-Identity | ReestabUE-Identity, |
| reestablishmentCause | ReestablishmentCause, |
| spare | BIT STRING (SIZE (2)) |

| } | |
|---|---|
| ReestabUE-Identity ::= | SEQUENCE { |

| | |
|---|---|
| c-RNTI | C-RNTI, |
| physCellId | PhysCellId, |
| shortMAC-I | ShortMAC-I |

| } | |
|---|---|
| ReestablishmentCause ::= | ENUMERATED { |

reconfigurationFailure, handoverFailure, otherFailure,

failureDueToIdc, handoverFailureDueToIdc }
-- ASN1STOP

In Table 5, if the reestablishment cause indicator indicates handoverFailureDueToIdc, it means that a cause of RRC connection reestablishment is a handover failure due to IDC. If the reestablishment cause indicator indicates failureDueToIdc, it means that a cause of RRC connection reestablishment is IDC (except a handover failure). If the reestablishment cause indicator indicates handoverFailure, it means that a cause of RRC connection reestablishment is a failure in the handover owing to causes other than IDC. If the reestablishment cause indicator indicates reconfigurationFailure, it means that a cause of RRC connection reestablishment is a failure in the common RRC connection reconfiguration process other than the above handover failures. If the reestablishment cause indicator indicates otherFailure, it means that a cause of RRC connection reestablishment is a cause other than the four kinds of causes.

If the reestablishment cause indicator included in the RRC connection reestablishment request message received by the eNB indicates handoverFailureDueToIdc and thus the eNB checks (or identifies or confirms) that a cause of the RRC connection is reestablishment is IDC due to the UE, the eNB may perform an IDC reduction without influencing handover parameters or network parameters. That is, the eNB does not modify the handover parameters because the handover failed, but the handover failure results from the IDC. Furthermore, if the UE has performed the RRC connection reestablishment, the UE may also perform an IDC reduction (e.g., TDM) in a target eNB or a target cell with reference to the occurrence of the IDC.

If the reestablishment cause indicator included in the RRC connection reestablishment request message received by the eNB indicates handoverFailure, a network may determine that handover parameters between eNBs or cells are not correctly set because the handover failed owing to causes other than IDC and thus modify the handover parameters between the eNBs or the cells. That is, handoverFailure indicates a handover failure not generated by IDC.

The RRC connection reestablishment request message shows an example including the RRC connection reestablishment cause indicator. The RRC connection reestablishment cause indicator may be included in the RRC connection reestablishment request message while having another name or form. The reestablishment cause indicator may be included in a message other than the RRC connection reestablishment request message and then transmitted. Furthermore, the reestablishment cause indicator may be independently transmitted to the eNB.

The eNB receives the RRC connection reestablishment request message from the UE as described above. In response thereto, the eNB checks (or identifies or confirms) a cause of the RLF at step S1940. Furthermore, the eNB sends an RRC connection reestablishment message to the UE at step S1950. The RRC connection reestablishment message may include information or parameters necessary for the UE to reestablish RRC connection. The UE may reestablish the RRC connection on the basis of the information or parameters. After reestablishing the RRC connection, the UE transmits an RRC connection reestablishment complete message to the eNB at step S1960.

Next, the eNB is operated on the basis of the RLF occurrence cause at step S1970. For example, the eNB may perform an operation of transferring the RLF occurrence cause to a network. If the RLF occurrence cause is IDC (e.g., if the reestablishment cause indicator indicates handoverFailureDueToIdc or failureDueToIdc), the eNB may perform an operation of reducing or avoiding the IDC (e.g., TDM, FDM, or PC) after RRC connection reestablishment is finished. That is, the eNB may perform the IDC reduction or avoidance operation on the basis of the RRC connection reestablishment operation of the UE.

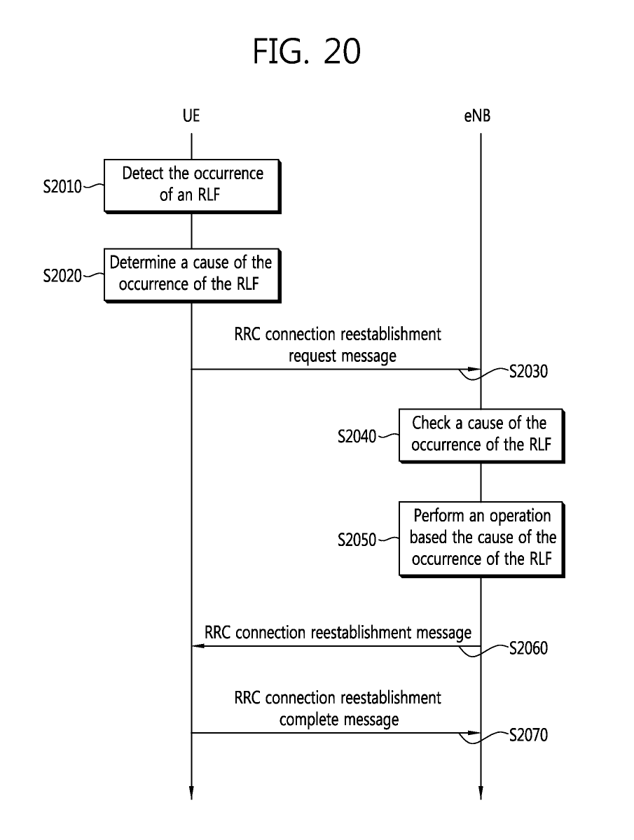

FIG. 20 shows another example of an RRC connection reestablishment operation according to an embodiment of the present invention.

In FIG. 20, the step S2010 of UE detecting the occurrence of an RLF, the step S2020 of the UE determining a cause of the occurrence of the RLF, the step S2030 of the UE requesting RRC connection reestablishment by sending an RRC connection reestablishment request message to an eNB, and the step S2040 of the eNB checking(or identying or confirming) a cause of the occurrence of the RLF (hereinafter referred to as an ‘RLF occurrence cause’) in response to the RRC connection reestablishment request message are the same as those of the is embodiment of FIG. 19.

In FIG. 20, unlike in FIG. 19, the eNB performs an operation based on the RLF occurrence cause before sending an RRC connection reestablishment message to the UE at step S2050. That is, the eNB may perform an operation of reducing or avoiding IDC during the RRC connection reestablishment process. Next, the eNB transmits the RRC connection reestablishment message to the UE at step S2060. The UE transmits an RRC connection reestablishment complete message to the eNB at step S2070. Thus, the RRC connection reestablishment is completed.

The embodiment of FIG. 20 is the same as the embodiment of FIG. 19 in that an operation related to IDC is performed based on an RLF occurrence cause from an eNB toward a network, but is different from the embodiment of FIG. 19 in that RRC connection reestablishment may be performed based on an IDC reduction operation (e.g., TDM).

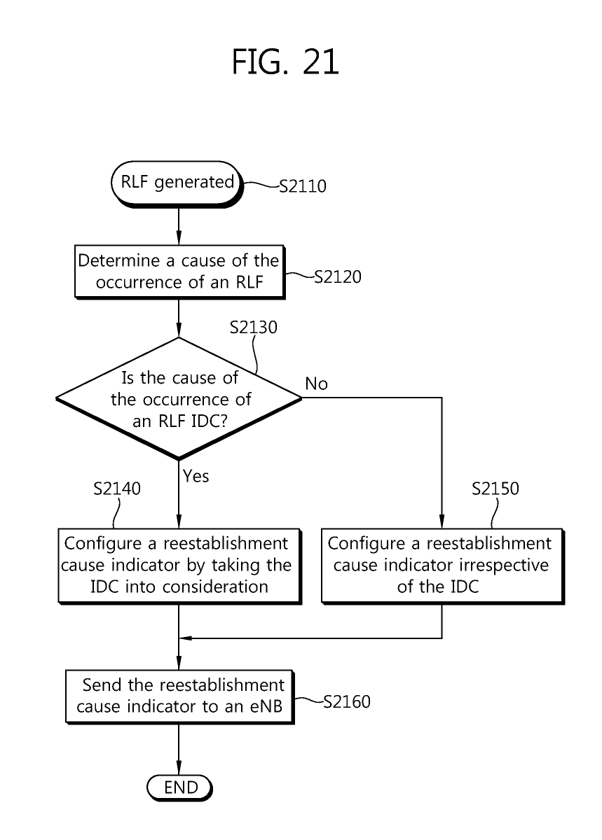

FIG. 21 is a flowchart illustrating an embodiment of an operation of UE according to an embodiment of the present invention.

Referring to FIG. 21, when an RLF was generated at step S2110, the UE determines a cause of the occurrence of the RLF at step S2120 and determines whether the RLF occurrence cause is IDC at step S2130. If, as a result of the determination, it is determined that the RLF occurrence cause is the IDC, the UE configures a reestablishment cause indicator by taking the IDC into consideration at step S2140. For example, when configuring the reestablishment cause indicator included in an RRC connection reestablishment request message transmitted to an eNB, the UE configures the reestablishment cause indicator depending on whether IDC exists or not. Meanwhile, if, as a result of the determination, it is determined that the RLF occurrence cause is not the IDC, the UE configures a common reestablishment cause is indicator irrespective of IDC at step S2150. Next, the UE transmits the configured reestablishment cause indicator to the eNB at step S2160. The reestablishment cause indicator may be included in the RRC connection reestablishment request message and then transmitted, but may be separately transmitted.

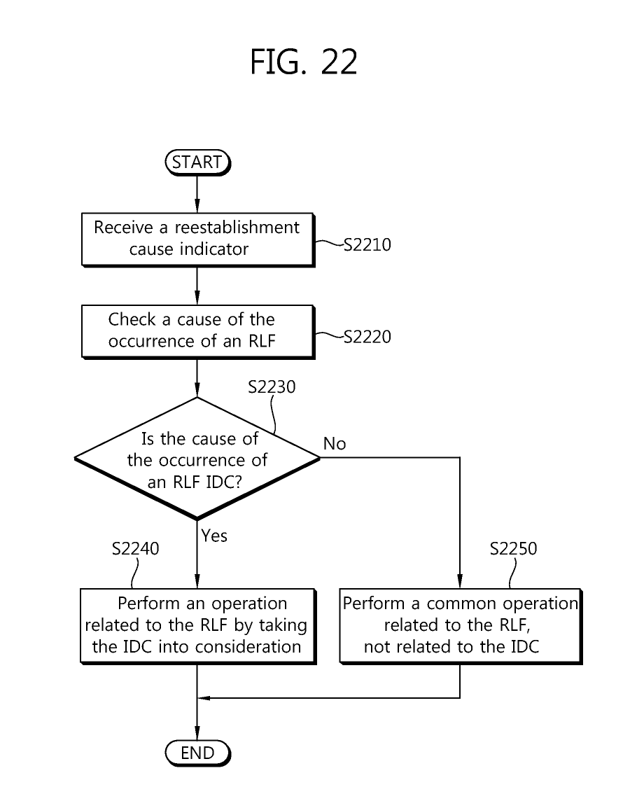

FIG. 22 is a flowchart illustrating an embodiment of an operation of an eNB according to an embodiment of the present invention.

Referring to FIG. 22, the eNB receives a reestablishment cause indicator at step S2210 and checks(or identifies or confirms) an RLF occurrence cause (or a reestablishment cause) at step S2220. Furthermore, the eNB determines whether the RLF occurrence cause is IDC at step S2230. If, as a result of the determination, it is determined that the RLF occurrence cause is the IDC, the eNB performs an operation related to the RLF by taking the IDC into consideration at step S2240. For example, the eNB may reduce the IDC or transmit the relevant problem to a network. Meanwhile, if, as a result of the determination, it is determined that the RLF occurrence cause is not the IDC, the eNB performs a common operation related to the RLF, which is not related to the IDC at step S2250.

In accordance with the embodiments of FIGS. 21 and 22, the UE and the eNB are operated so that IDC does not have an effect when the network modifies the network parameters.

If a reestablishment cause indicator received by an eNB indicates a handover failure, a network may determine that handover parameters between eNBs or cells are not correctly set and thus modify the handover parameters between the eNBs or the cells. In general, parameters related to a handover failure may be related to interference between relevant cells according to cell deployment or a change of a channel according to pathloss.

As described above, it is preferred that IDC due to UE does not have an effect on is the existing network parameters. Accordingly, in case of a handover failure due to IDC, UE informs an eNB that an RLF occurrence cause is a cause other than the handover failure so that a network does not know the handover failure. The network does not modify network parameters or handover parameters because it knows that there was no the handover failure.

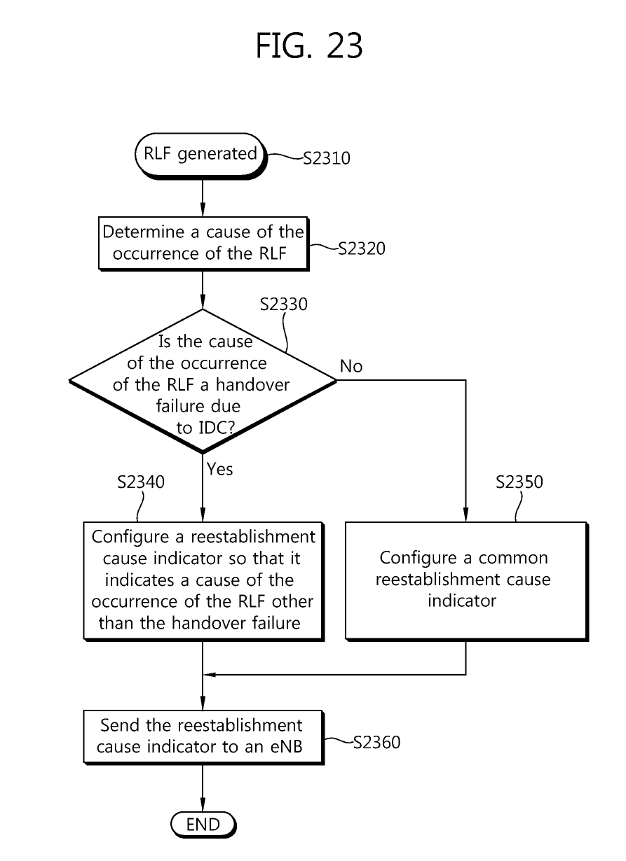

FIG. 23 is a flowchart illustrating another embodiment of an operation of UE according to an embodiment of the present invention.

Referring to FIG. 23, when an RLF was generated at step S2310, the UE determines an RLF occurrence cause at step S2320 and determines whether the RLF occurrence cause is a handover failure due to IDC at step S2230.

If, as a result of the determination, it is determined that the RLF occurrence cause is a handover failure due to the IDC, the UE configures a reestablishment cause indicator so that it indicates another RLF occurrence cause other than a handover failure at step S2340. That is, the reestablishment cause indicator indicates that the RLF occurrence cause is another RLF occurrence cause (e.g., otherFailure) not the handover failure so that a network does not know the handover failure. In this case, the IDC does not have an effect when the network modifies network parameters.

Even in case of a handover failure due to the IDC, if an eNB determines that the RLF occurrence cause is a handover failure, the network may determine that handover parameters between eNBs or cells are not correctly set and thus modify the handover parameters the eNBs or the cells. Accordingly, the handover parameters have an effect on network parameters according to the existing deployment because the handover parameters are related to interference between relevant cells according to cell deployment or a change of a channel according to pathloss.

Meanwhile, if, as a result of the determination at step S2330, it is determined that the RLF occurrence cause is not a handover failure due to the IDC, the UE configures a common reestablishment cause indicator as in the embodiment of FIG. 21 at step S2350. In other words, the UE may configure the common reestablishment cause indicator so that the common reestablishment cause indicator indicates that the RLF occurrence cause is the IDC, but not a handover failure, the common reestablishment cause indicator indicates that the RLF occurrence cause is a handover failure not related to the IDC, or the common reestablishment cause indicator indicates the occurrence of an RLF due to other cases.

The UE transmits the configured reestablishment cause indicator to the eNB at step S2360.

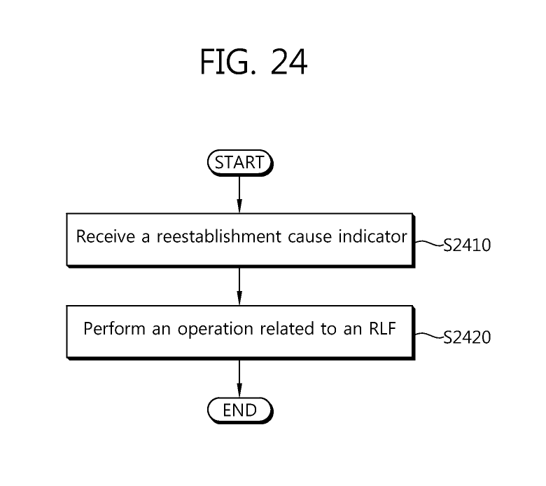

FIG. 24 is a flowchart illustrating another embodiment of an operation of an eNB according to an embodiment of the present invention.

Referring to FIG. 24, the eNB receives a reestablishment cause indicator from UE at step S2410 and performs an operation related to an RLF at step S2420.

The eNB performs a common operation related to the RLF on the basis of the reestablishment cause indicator configured by the UE. If the reestablishment cause indicator indicates a handover failure, the eNB has only to perform an RLF operation related to the handover failure because the RLF is a common handover failure not a handover failure due to IDC.

In the embodiment of FIG. 23, the UE has configured the reestablishment cause indicator as if a handover failure due to the IDC is not a handover failure. Accordingly, although a handover failure results from the IDC, the eNB dos not determine that an RLF was generated owing to the handover failure, and thus the network does not change handover parameters or is network parameters.

In the above example, if an RLF due to IDC was generated although the RLF was not generated owing to a handover failure due to IDC, another RLF occurrence cause (e.g., otherFailure) may be indicated so that an eNB does not known a relevant cause as in the example.

Other embodiments in which pieces of information regarding an RLF generated due to IDC are handled are described below.

In an embodiment, an RLF generated due to IDC may be transferred through separate signaling. All the cases in which the RLF was generated may be clearly transferred. Which one (e.g., RLF occurrence cause information and IDC measurement information) of the pieces of information regarding an RLF generated due to IDC is necessary for a network has to be first discussed.

In another embodiment, in order to transfer RLF information generated due to IDC, the existing signaling may be used. When an RLF was generated owing to IDC, an RLF occurrence cause may be set to “other cases” (e.g., otherFailure). A new Information Element (IE) or a new RLF report is not necessary because the RLF information is transferred through the existing signaling.

For example, in relation to an RLF report on a UE information process, an eNB (or an Evolved Universal mobile telecommunications system Terrestrial Radio Access Network (EUTRAN)) may estimate whether an RLF occurrence cause is IDC based on measurement results or not.

Likewise, the eNB may smartly disregard a meaninglessly reported RLF. In accordance with the present embodiment, although an RLF occurrence cause may not be is correctly known, a network may be sufficiently informed of necessary RLF information due to IDC.

As another embodiment, the occurrence of an RLF due to IDC may be disregarded by UE. If information related to the RLF generated owing to the IDC is determined not to be necessary for a network, the UE disregards all RLFs generated owing to IDC.

In accordance with the present embodiment, although an RLF was generated owing to IDC, the UE should not record RLF information. Accordingly, a network is no longer influenced by the RLF generated owing to IDC, and thus the network does not know why the RLF was generated owing to IDC.

Meanwhile, in another example of the present embodiment, when an RLF was generated owing to IDC, UE may record RLF information, but may not report the RLF information. Accordingly, a network is no longer influenced by the RLF generated owing to IDC, and thus the network does not know why the RLF was generated owing to IDC. However, the network may receive a report on a cause of the IDC at the request of an eNB and then transfer the recorded information to the eNB. Furthermore, UE may use relevant information in order for the UE to be subject to an operation test.

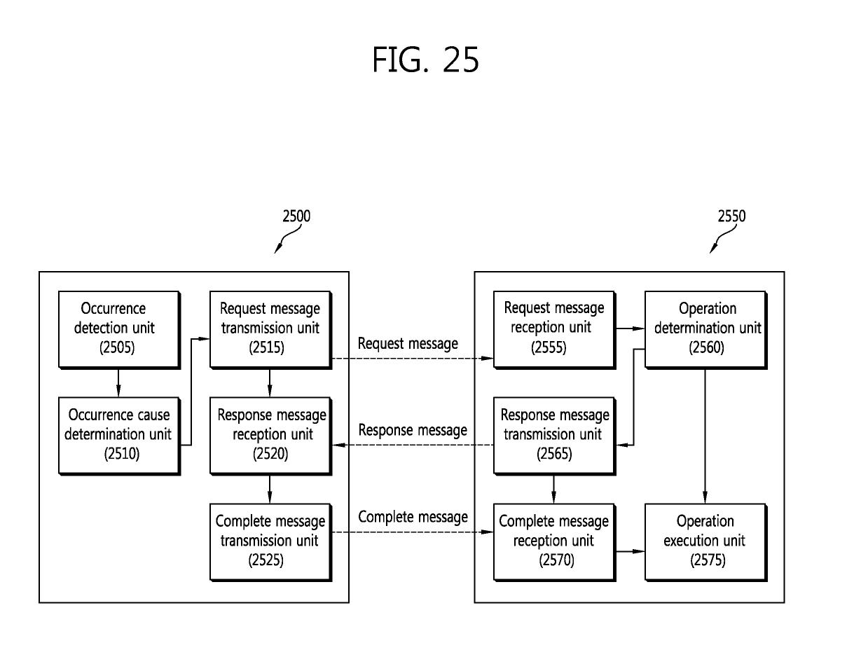

FIG. 25 is a block diagram of an apparatus for reestablishing RRC connection according to an embodiment of the present invention.

Referring to FIG. 25, UE 2500 and an eNB 2550 exchanges pieces of information regarding IDC. The pieces of information regarding IDC include an RRC connection reestablishment request message transmitted by the UE 2500 and a response message transmitted by the eNB 2550.

The UE 2500 may include an occurrence detection unit 2505 for detecting the is occurrence of an RLF, an occurrence cause determination unit 2510 for determining an RLF occurrence cause, a request message transmission unit 2515, a response message reception unit 2520, and a complete message transmission unit 2525.

The RLF occurrence detection unit 2505 detects whether an RLF was generated. At this time, the RLF occurrence cause determination unit 2510 determines whether the RLF occurrence cause is the occurrence of IDC.

A method of the occurrence cause determination unit 2510 determining IDC may be various. First, if the UE detects that IDC occurred when an RLF occurred (or before or after the RLF occurred), the occurrence cause determination unit 2510 may determine that the RLF was generated owing to the IDC. Second, if the UE detects that IDC was generated when an RLF occurred (or before or after the RLF occurred) and the intensity of the IDC is a preset threshold or higher, the occurrence cause determination unit 2510 may determine that the RLF was generated owing to the IDC. The intensity of the IDC may be known based on the intensity of only the IDC or may be known based on the measurement results of RSRP or RSRQ. The intensity of the IDC may be known by determining an RSRQ value because the RSRQ value will be reduced by the IDC. If the intensity of the RSRQ value is smaller than a preset threshold, the occurrence cause determination unit 2510 may determine that the RLF was generated owing to the IDC. Third, the occurrence cause determination unit 2510 may determine that the RLF was generated owing to the IDC by determining whether packet loss has occurred. If the UE detects that IDC was generated when an RLF occurred (or before or after the RLF occurred) and detects the occurrence of packet loss, the occurrence cause determination unit 2510 may determine that the RLF was generated owing to the IDC.

The request message transmission unit 2515 generates an RRC connection is reestablishment request message based on the RLF occurrence information detected by the RLF occurrence detection unit 2505 and the RLF occurrence cause determined by the occurrence cause determination unit 2510 and transmits the RRC connection reestablishment request message to the eNB 2550. The request message may include a reestablishment cause indicator indicating whether the RLF occurrence cause results from IDC. The reestablishment cause indicator may also indicate whether a handover failure results from IDC.

For example, if the reestablishment cause indicator indicates handoverFailureDueToldc, it means that a cause of RRC connection reestablishment is a handover failure due IDC. If the reestablishment cause indicator indicates failureDueToldc, it means that a cause of RRC connection reestablishment is IDC (except a handover failure). If the reestablishment cause indicator indicates handoverFailure, it means that a cause of RRC connection reestablishment is a handover failure due to a cause other than IDC. If the reestablishment cause indicator indicates reconfigurationFailure, it means that a cause of RRC connection reestablishment is a failure in the common RRC connection reconfiguration process other than the above-described handover failure. If the reestablishment cause indicator indicates otherFailure, it means that a cause of RRC connection reestablishment is a cause other than the four kinds of causes.

The response message reception unit 2520 receives a response message from the eNB 2550. The response message may include information that is necessary for the UE to perform RRC connection reestablishment. The UE may reestablish RRC connection based on the response message and may also reduce IDC (e.g., TDM) in a target eNB or a target cell with reference to the occurrence of IDC.

When the UE 2500 completes the RRC connection reestablishment, the complete is message transmission unit 2525 transmits a complete message to the eNB 2550.

The eNB 2550 may include a request message reception unit 2555, an operation determination unit 2560, a response message transmission unit 2565, a complete message reception unit 2570, and an operation execution unit 2575.

The request message reception unit 2555 receives a request message, requesting RRC connection reestablishment, from the UE 2500.

The operation determination unit 2560 may check(or identifies or confirms) whether an RLF was generated owing to IDC based on a reestablishment cause indicator included in the request message and determines an operation to be performed as a result of the check(or identitie or confirmation). The operation determination unit 2560 may determine an operation related to the RLF by taking the IDC into consideration. For example, if the reestablishment cause indicator indicates failureDueToIDC and thus a cause of the RRC connection reestablishment is IDC due to UE, the operation determination unit 2560 may determine an operation of reducing the IDC without affecting handover parameters or network parameters. In contrast, the operation determination unit 2560 may make a determination so that a common operation related to the RLF, which is not related to the IDC. For example, if the reestablishment cause indicator indicates handoverFailure and thus a cause of the RRC connection reestablishment is a handover failure, the operation determination unit 2560 may determine an operation so that a network correctly modifies handover parameters between eNBs or cells.

The response message transmission unit 2565 generates a response message indicating an RRC connection reconfiguration and transmits the response message to the UE 2500. The complete message reception unit 2570 receives a complete message from the UE 2500 which has completed the RRC connection reestablishment.

The operation execution unit 2575 performs an operation determined by the operation determination unit 2560. For example, the operation execution unit 2575 may perform an IDC reduction operation based on the TDM or FDM scheme. The IDC reduction operation may include a cell reconfiguration, a handover, a frequency shift, or frequency shaping.

In accordance with the present invention, a cause of the occurrence of a Radio Link Failure (RLF) occurring during a handover in a network can be known. In particular, whether the cause is a handover failure or an RLF generated due to IDC can be known. Accordingly, a radio link can be efficiently reestablished and, at the same time, network parameters can be controlled.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed to limit the technical spirit of the present invention, but should be construed to illustrate the technical spirit of the present invention. The scope of the technical spirit of the present invention is not limited by the embodiments, and the scope of the present invention should be interpreted based on the following appended claims. Accordingly, the present invention should be construed to cover all modifications or variations induced from the meaning and scope of the appended claims and their equivalents.

1. A method of User Equipment (UE) reestablishing a radio link in a wireless communication system, the method comprising:
detecting an occurrence of a Radio Link Failure (RLF) between the UE and an evolved NodeB (eNB);
determining a cause of the occurrence of the RLF;
generating a Radio Resource Control (RRC) connection reestablishment request message, including an RRC connection reestablishment cause indicator indicating whether the cause of the occurrence of the RLF is In-Device Coexistence interference (IDC) of the UE; and
sending the RRC connection reestablishment request message to the eNB.

2. The method as claimed in claim 1, further comprising:
receiving an RRC connection reestablishment message from the eNB; and
reestablishing the failed radio link based on the RRC connection reestablishment message.

3. The method as claimed in claim 1, wherein determining a cause of the occurrence of the RLF is performed based on measurement results of Reference Signal Received Power (RSRP), Reference Signal Received Quality (RSRQ), a Channel Quality Indication (CQI), or a Signal to Interference and Noise Ratio (SINR).

4. The method as claimed in claim 1, wherein determining a cause of the occurrence of the RLF is performed based on whether the IDC was generated owing to the UE.

5. The method as claimed in claim 1, wherein determining a cause of the occurrence of the RLF is performed based on whether a packet has been lost owing to the IDC due to the UE.

6. The method as claimed in claim 1, wherein the RRC reestablishment cause indicator further indicates whether the cause of the occurrence of the RLF is a handover failure due to the IDC of the UE.

7. A User Equipment (UE) to perform Radio Resource Control (RRC) connection reestablishment in a wireless communication system, the UE comprising:
an occurrence detection unit to detect an occurrence of a Radio Link Failure (RLF) between the UE and an evolved NodeB (eNB);
an occurrence cause determination unit to determine a cause of the occurrence of the RLF; and
a request message transmission unit to generate an RRC connection reestablishment request message, including an RRC connection reestablishment cause indicator indicating whether the cause of the occurrence of the RLF is In-Device Coexistence interference (IDC) of the UE, and to send the RRC connection reestablishment request message to the eNB.

8. The UE as claimed in claim 7, further comprising a response message reception unit to receive an RRC connection reestablishment message from the eNB.

9. The UE as claimed in claim 7, wherein the occurrence cause determination unit determines the cause of the occurrence of the RLF based on measurement results of Reference Signal Received Power (RSRP), Reference Signal Received Quality (RSRQ), a Channel Quality Indication (CQI), or a Signal to Interference and Noise Ratio (SINR).

10. The UE as claimed in claim 7, wherein the RRC reestablishment cause indicator further indicates whether the cause of the occurrence of the RLF is a handover failure due to the IDC of the UE.

11. A method of an evolved NodeB (eNB) reestablishing a radio link in a wireless communication system, the method comprising:
receiving a Radio Resource Control (RRC) connection reestablishment request message, including an RRC connection reestablishment cause indicator indicating whether a cause of radio link reestablishment is In-Device Coexistence interference (IDC) of a User Equipment (UE), from the UE;
identifying a cause of the occurrence of the RLF based on the RRC connection reestablishment cause indicator;
generating an RRC connection reestablishment message based on the cause of the occurrence of the RLF; and
sending the RRC connection reestablishment message to the UE.

12. The method as claimed in claim 11, further comprising performing an operation of reducing the IDC of the UE based on the cause of the occurrence of the RLF.

13. The method as claimed in claim 11, wherein the RRC connection reestablishment cause indicator indicates whether the cause of the occurrence of the RLF is a handover failure due to the IDC of the UE.

14. An evolved NodeB (eNB) to perform radio link reestablishment in a wireless communication system, the eNB comprising:
a request message reception unit to receive a Radio Resource Control (RRC) connection reestablishment request message, including an RRC connection reestablishment cause indicator indicating whether a cause of the radio link reestablishment is In-Device Coexistence interference (IDC) of a User Equipment (UE), from the UE;
an operation determination unit to identify a cause of the occurrence of the RLF based on the RRC connection reestablishment cause indicator and determine an operation to be performed; and
a response message transmission unit to send an RRC connection reestablishment message generated based on the cause of the occurrence of the RLF to the UE.

15. The eNB as claimed in claim 14, further comprising an operation execution unit to perform an operation of reducing the IDC of the UE based on the cause of the occurrence of the RLF.
